(19) United States
(12) Patent Application Publication
(10) Pub. No.: US 2015/0080797 A1
(43) Pub. Date: Mar. 19, 2015

(54) DEVICE FOR CHECKING INDWELLING SITE

(71) Applicant: Susumu Miyasaka, Fukuroi (JP)

(72) Inventor: Susumu Miyasaka, Fukuroi (JP)

(73) Assignee: Covidien LP, Mansfield, MA (US)

(21) Appl. No.: 14/343,619

(22) PCT Filed: Aug. 23, 2012
(86) PCT No.: PCT/US2012/052093

§ 371 Date: Nov. 5, 2014

(30) Foreign Application Priority Data
Sep. 20, 2011 (JP) 2011-205025

(51) Int. Cl. A61J 15/00

(52) U.S. Cl. CPC A61J 15/0003; A61J 2015/0084
USPC 604/111

(57) ABSTRACT

A device for checking indwelling site capable of checking the indwelling site of a medical tube through multiple checking operations by simple techniques using a single device is disclosed. The device for checking indwelling site is provided with a barrel, a first plunger having a torso member and a hole formed communicating between the inner cavity of the torso member and the inner cavity of the barrel and disposed capable of pushing into or pulling out while keeping the barrel airtight, a second plunger having a second tip member and disposed capable of pushing into or pulling out while keeping the torso member airtight, a space formed between an inner wall and the tip face of the first tip member and designed to suck the gas fraction of the fluid sucked into the barrel into the torso member, and a detecting member arranged inside the torso member on the tip side of the second tip member and designed to react with carbon dioxide sucked in through the space by discoloring.

### FIELD

The present invention relates to a device for checking indwelling site, which checks the indwelling site of a medical tube indwelled in the digestive tract, such as the stomach and the duodenum.

### BACKGROUND

Persons whose food intake function has decreased due to, for example, advanced age or disease, “patients,” must be assisted through some sort of means in taking in nutrition required to maintain life. One conventional example of such is a medical tube that is inserted orally or intranasally and indwelled in the digestive tract, such as the stomach and the duodenum, to administer nutrition (so-called feeding tube). Such a medical tube is designed to be indwelled in the digestive tract, such as the stomach and the duodenum, by inserting the tip into the esophagus side. In some cases, however, the tip is mistakenly inserted into the respiratory tract side, and consequently the medical tube is mistakenly indwelled in the lower respiratory tract, such as the bronchi or lungs.

In such cases, if the patient is an ordinary patient, they often either cough or vomit to prevent erroneous indwelling. If such a medical tube is inserted into a patient who is of advanced age or unconscious, however, such living body reactions as coughing or vomiting might not necessarily occur. Therefore, some sort of means or methods is necessary in order to check the indwelling site of a medical tube. Generally, the following means are used: checking by means of the air bubble generated when air is injected into the stomach, checking based on whether or not the stomach contents can be sucked in (including visual observation), checking based on the pH of the stomach contents sucked in and collected from the stomach, checking by means of X-ray radiography, or checking by means of an endoscope mounted on the tip of the tube.

For example, in a publication titled Healthcare Safety Information. “No. 8: Preventing Accidental Erroneous Insertion or Injection of Intranasal Feeding Tubes,” the Japanese Nursing Association recommends that the indwelling site of a feeding tube be checked every time when giving nutrients or the like through an inserted feeding tube by determining whether or not the gastric juice (stomach contents) can be sucked in and whether or not the air bubble sounds can be detected by means of radiography or litmus paper.

In addition to the above, a technique has been disclosed for checking the indwelling site of a feeding tube by means of gastric juice pH are disclosed (for example, see Japanese Kokai Patent Publication No. 62-298331). A technique has also been disclosed for checking the indwelling site of a tube indwelt, in the respiratory tract by means of carbon dioxide (for example, see U.S. Pat. No. 5,124,129).

In a technique such as described in Japanese Kokai Patent Publication No. 62-298331, an attempt to suck in gastric juice from the stomach of a patient might fail depending on how gastric juice accumulates in the patient. A technique such, as described in U.S. Pat. No. 5,124,129 requires mounting and dismounting a carbon dioxide detection device instead of a syringe, which makes the technique cumbersome. When an indwelling site is checked by means of air bubble sounds, instead of directly collecting the gastric juice, the indwelling site is checked just by indirectly listening to sounds which include considerable noise, making it difficult to accurately determine the indwelling site. Therefore, such a technique lacks reliability.

Although radiography increases the level of reliability, such a method is not desirable from the standpoint of decreasing exposure to medical radiation as much as possible. Radiography also requires large-scale equipment, which is inconvenient, and not cost-effective when checking each time. The method using litmus paper requires dripping suctioned gastric juice onto litmus paper, which makes the technique cumbersome. Using an endoscope mounted on the tip of the medical tube increases the level reliability, but such a method requires large-scale equipment and a high level of operator expertise.

Moreover, the indwelling site of a medical tube cannot be accurately checked by any one method alone. The indwelling site of a medical tube cannot be accurately checked even using X-ray. In addition, although combining a plurality of checking methods is said to be standard procedure, using the equipment and tools needed for a plurality of checking methods makes the equipment bulky and the checking procedure complicated. On the other hand, considering future rising demand for medical tubes, it will be increasingly important to be able to carry out a plurality of checks without requiring large-scale equipment or a high level of specialization.

### SUMMARY

In accordance with one or more aspects, the present invention can provide a device for checking indwelling site capable of carrying out a plurality of operations for checking the indwelling site of a medical tube by simple techniques using a single device.

In accordance with one or more aspects, the device for checking indwelling site of the present invention can check the indwelling site of the tip of a medical tube, provided with a barrel for connecting to the medical tube, a first plunger having a hollow torso member and a first tip member disposed on the tip of the torso member and having a hole formed communicating between the inner cavity of the torso member and the inner cavity of the barrel, and disposed capable of pushing into or pulling out of the barrel, a second plunger having a second tip member and that is disposed capable of pushing into or pulling out of the torso member of the first plunger, and a carbon dioxide detecting member that is arranged inside the torso member and closer to the tip than to the second tip member, wherein the first plunger is restricted from moving towards the tip at a location where the first tip member does not contact the inner wall of the barrel on the tip side, and has a space having a predetermined volume formed between the tip face of the first tip member and the inner wall of the barrel on the tip side.

In accordance with one or more aspects, the device for checking indwelling site of the present invention can carry out a plurality of checking operations using a single device and by simple techniques, and thus can greatly improve the reliability of checking whether or not the tip of a medical tube has been indwelled appropriately.

### BRIEF EXPLANATION OF THE DRAWINGS

FIG. 1 is a schematic view showing the overall configuration, of a device for checking indwelling sites according to Embodiment 1 of the present invention.

FIG. 2 is an enlarged schematic view showing an enlargement of a part of the device for checking indwelling sites according to Embodiment 1 of the present invention.

FIG. 3 is a schematic view showing the overall configuration of a device for checking indwelling sites according to Embodiment 2 of the present invention.

Embodiments of the present invention will be described hereinafter using the attached drawings as a reference.

### DETAILED DESCRIPTION

### Embodiment 1

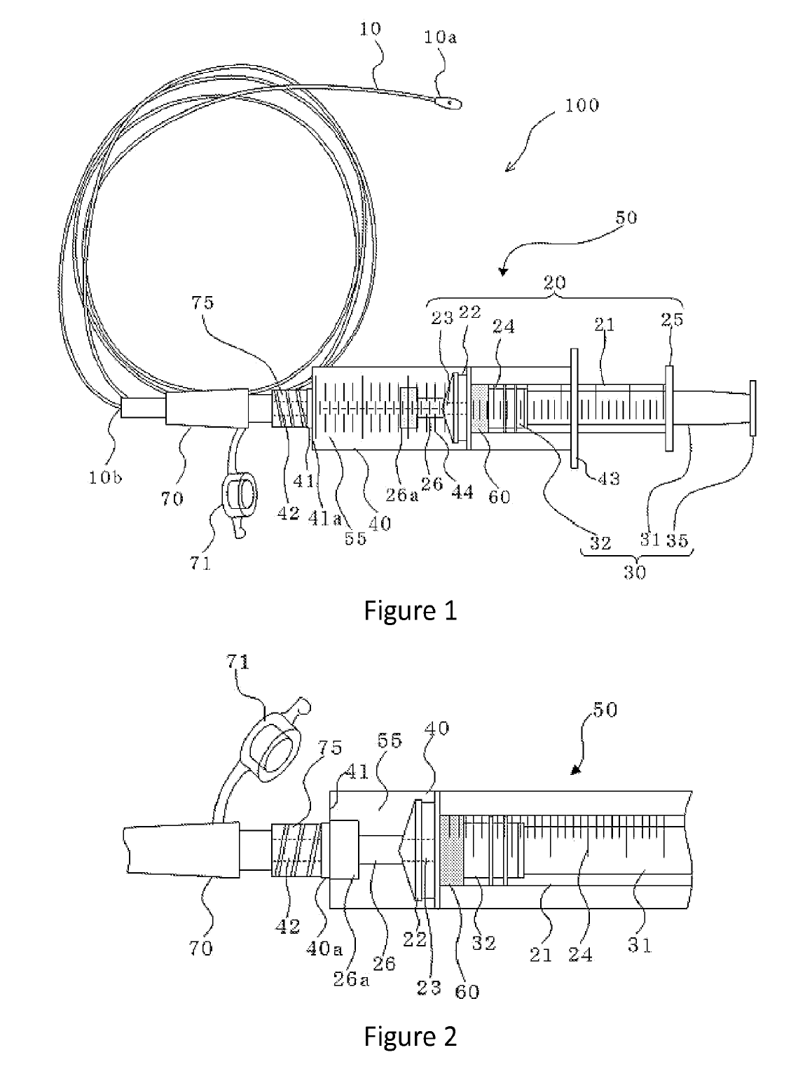

FIG. 1 is a schematic view showing the overall configuration of a device for checking indwelling site of Embodiment 1 of the present invention (hereafter, referred to as the device 100). FIG. 2 is an enlarged schematic view showing an enlargement of a part of the device 100. The device 100 will be described using FIGS. 1 and 2 as a reference. It will be noted that the relative size of the parts may differ from the actual size of the parts in the drawings, including FIG. 1. FIG. 2 also omits the scale 44 on the barrel 40.

The device 100 is a medical device used when inserting a medical tube 10 orally or intranasally to indwell a tip 10a thereof in the digestive tract, such as the stomach or duodenum, and thereby administer nutrition or cause the contents of the digestive tract to be discharged from the digestive tract. The device 100 can inject air for listening to and checking air bubble sounds when inserting the medical tube 10 or administering nutrients, allowing at least checking operations to be carried out using a single device; namely, detecting and checking body fluids, and detecting and checking carbon dioxide. Specifically, the more checking operations that are carried out, the more likely it is to detect erroneous insertion and indwelling of the tip 10a. The device 100 can achieve a plurality number of checking operations using a single device, and thus enhances the reliability of determining the indwelling site of the tip 10a.

Configuration of Device 100

As exemplarily shown, in FIG. 1, the device 100 can comprise the medical tube 10, a syringe 50, a detecting member such as a carbon dioxide detecting member 60 (hereafter, simply referred to as the detecting member 60), an adaptor 70, and a connector 75. In the following explanation, the side to be inserted into the patient (the patient side) is called the tip side or tip end, and the side to be operated by the operator (the operator side) is called the base side or base end.

Medical Tube 10

The medical tube 10 is typically a flexible tubular material, and may be formed of a synthetic resin such as, for example, polyurethane or polyvinyl chloride. The medical tube 10 has a tip 10a and a base 10b. The tip 10a is designed to indwell in the digestive tract, such as the stomach or the duodenum, and the base 10b is designed to be connected to the adaptor 70. The shape of the tip 10a is not specifically limited, but it, should be a shape that does not damage the part of the medical tube 10 to be inserted. The tip 10a also functions as a weight to facilitate inserting the medical tube 10 through peristaltic movements. An opening, through which fluid passes when supplying nutrients or sucking in the content, inside the digestive tract, can be formed on the tip 10a. The base 10b can have a shape capable of connecting to the adaptor 70 (for example, a shape capable of inserting into the adaptor 70 shown in FIG. 1).

A guide wire for facilitating insertion into the digestive tract may be inserted into the inner cavity of the medical tube 10 beforehand in a manner allowing later withdrawal. When inserting the guide wire into the inner cavity of the medical tube 10, the tip of the guide wire is typically positioned to the inside of the tip 10a of the medical tube 10. The guide wire can assist in inserting the medical tube 10 into the digestive tract such as the stomach and the duodenum. The guide wire may be inserted into the inner cavity of the medical tube 10 through the adaptor 70. The base of the guide wire may be fixed by the adaptor 70 or may protrude from the adaptor 70.

Although Embodiment 1 was described for an example in which the medical tube 10 is a feeding tube, the medical tube is not limited to a feeding tube, and the medical tube 10 may be a tube other than a feeding tube (for example, a drain tube) to be indwelt in the digestive tract. Although a drain tube and a feeding tube typically have different diameters, the method for indwelling these tubes in the digestive tract is similar.

Syringe 50

The syringe 50 typically has at least a barrel 40 attached by a connector 75 to a tip member 41 and through which a first plunger 20 is pushed in or pulled out from the base side. The first plunger 20 is typically disposed to be capable of freely pushing into or pulling out of the barrel 40. A second plunger 30 is typically disposed to be capable of freely pushing into or pulling out from within the first plunger 20, for example, the inside of a torso member 21, and a space-forming member 26 disposed on the tip of the first plunger 20 and designed to assure a space of a predetermined volume between the inside of the barrel 40 and a first tip member 22.

First Plunger 20

The first plunger 20 typically comprises the hollow torso member 21 having the second plunger 30 disposed inside capable of freely pushing in or pulling out, and the first tip member 22 disposed on the tip of the torso member 21 and having a hole 23 formed communicating between the outside, specifically, the inner cavity of the barrel 40, and the inner cavity of the torso member 21. When force applied by the operator is transmitted through the torso member 21, the first plunger 20 typically is pushed into and pulled out of barrel 40 so as to vary the pressure in the barrel 40. For example, the first plunger 20 can suck fluids (liquids (digestive fluids such as gastric juice), gasses (gasses such as carbon dioxide), or mixtures thereof) into the barrel 40 when pulled by the operator; and drain the fluids in the barrel 40 when pushed.

The torso member 21 can serve to transmit force applied by the operator. It comprises a clear synthetic resin, for example, in a manner so that the cross-section thereof is circular or polygonal (such as a hexagon or octagon). Embodiment 1 shows an example in which the cross-section of the torso 21 is circular. As exemplarily shown in FIG. 2, a scale 24 may be disposed on the outer wall of the torso member 21. If provided, the scale 24 is helpful in determining the volume of the fluid (gas) sucked into the torso member 21. Although the drawings show an operating member 25, for assisting the operation of pushing in or pulling out the first plunger 20, provided on the periphery on the base of the torso member 21, the operating member 25 is optional, and is not essential.

The first tip member 22 typically is mounted on the periphery of the tip of the torso member 21 through fitting, screwing, adhering, or welding, and the peripheral surface thereof contacts the inner wall of the barrel 40. When force is transmitted by the operator to the first plunger 20, the first plunger 20 typically is pushed or pulled so that the peripheral surface of the first tip member 22 slides on the inner wall of the barrel 40. An example of the material comprising the first tip member 22 is a gasket or the like. The hole 23 for communicating between the inside of the barrel 40 and the inside of the first plunger 20 is formed in the approximate center of first tip member 22. When equipped with a hydrophobic filter, the hole 23 prevents fluids from flowing into the torso member 21.

Because the second plunger 30 (to be described later) keeps the inside of the torso member 21 airtight, the inside of the barrel 40 can be kept airtight even when the hole 23 is formed on the first tip member 22.

The tip of the torso member 21 may be covered by the first tip member 22, and a cylindrical member passing through the hole 23 formed on first tip member 22 may disposed on the tip of the torso member 21. If the cylinder member is provided, the torso member 21 needs to have a bottom of a cylindrical shape, on the tip of which a through hole is formed. The cylinder member may also be formed so as to protrude from the center of the bottom. The first tip member 22 may be formed so as to be integrated with the torso member 21. Although the material comprising the first tip member 22 is not specifically limited, considering contact with the inner wall of the barrel 40, this material is preferably a flexible material; for example, an elastomer such as a rubber or a synthetic resins.

Second Plunger 30

The second plunger 30 typically comprises a stick-like member 31 disposed capable of pushing in or pulling out of the inside of the torso member 21 of first plunger 20, and a second tip member 32 disposed on the tip side. When force applied by the operator is transmitted through the stick-like member 31, the second plunger 30 is either pushed into or pulled out of the inside of the torso member 21 of the first plunger 20. The second plunger 30 can suck in fluids (gasses) inside the torso member 21 of the first plunger 20 when pulled by the operator, and drain the fluids inside the torso member 21 of the first plunger 20 when pushed by the operator.

The stick-like member 31 typically serves to receive the force applied by the operator, and this member may be constituted with a synthetic resin, etc. Although not specifically limited in cross-sectional shape, the stick-like member 31 need not be hollow inside, unlike the torso member 21 of the first plunger 20, which must be hollow inside.

Although the drawings show an operating member 35, for assisting the operation of pushing in or pulling out the second plunger 30, provided on the periphery on the base of the stick-like member 31, the operating member 35 is optional, and is not essential.

The second tip member 32 typically is mounted on the periphery of the tip of the torso member 31 through fitting, screwing, adhering, or welding, and the peripheral surface thereof contacts the inner wall of the torso member 21 of the first plunger 20, making the inside of the torso member 21 of the first plunger 20 airtight. When force is transmitted by the operator to the second plunger 30, the second plunger 30 is pushed or pulled so the peripheral surface of the second tip member 32 slides on the inner wall of the torso member 21 of the first plunger 20. An example of the material comprising the second tip member 32 is a gasket or the like. The second tip member 32 may also be formed integrated with the stick-like member 31. Although the material comprising the second tip member 32 is not especially limited, considering contact with the inner wall of the torso member 21 of the first plunger 20, the material is preferably a flexible material; for example, an elastomer such as a rubber or a synthetic resins.

Barrel 40

The barrel 40 typically is a cylinder having an inside that can be visually checked, a through hole formed on the tip member 41, and a bottom. The barrel typically is linked to the medical tube 10, which can be freely mounted or dismounted through the connector 75 and the adaptor 70. The barrel 40 comprises, for example, a clear synthetic resin, and is formed into a shape of which the cross-sectional plane is circular or polygonal (such as a hexagon or an octagon). Embodiment 1 of a barrel 40 having a circular cross section.

A cylinder 42 typically is formed so as to project from the central portion of the tip member 41 of the barrel 40 and capable of freely mounting or dismounting by means of a connector 75, which is fit or screwed on. Embodiment 1 shows an example of the cylinder 42 formed in the central portion of the tip member 41. However, the location where the cylinder 42 is formed is not specifically limited, and the cylinder 42 may be formed at a different location from the central portion of the tip member 41.

As exemplarily shown in FIG. 1, a scale 44 may be disposed on the outer wall of barrel 40. If provided, the scale 44 is helpful for determining the volume of the fluid (gas, liquid, or a mixture of both) sucked into the torso member 21. The drawings show an operating member 43, for assisting the operation of pushing in or pulling out the first plunger 20 and projecting peripherally, provided on the periphery on the base opposite the tip member 41 of the barrel 40. This operating member 43 coordinates with the operating member 25 and the operating member 35 to contribute to the operations by the operator. The operating member 43 is optional, however, and is not an essential member.

Space-Forming Member 26

The space-forming member 26 typically is provided on the tip of the first plunger 20, or more specifically on the tip face of the first tip member 22, so as to protrude towards the tip side, and forms a space 55 of a predetermined volume between the inner wall of the barrel 40 (hereafter, referred to as the inner wall 41a) on the tip side and the tip face of the first tip member 22. The space-forming member 26 can in some cases also function as a stopper that restricts the movement of the first plunger 20 towards the tip side at a predetermined location (a location at which the first tip member 22 does not contact the inner wall 41a of the barrel 40 on the tip side; specifically, at a location that assures a predetermined volume capable of storing the liquid fraction of the sucked-in fluid). Providing the space-forming member 26 allows the liquid fraction of the fluid sucked into the barrel 40 to be stored in the space 55, and enables intake of just the gas fraction into the torso member 21 of the first plunger 20.

The space 55 typically has a predetermined volume allowing storage of the liquid fraction of the sucked-in fluid. Specifically, the space 55 has a larger volume than when the inner wall 41a on the tip side of the barrel 40 contacts the tip face of first tip member 22. In the device 100, the space-forming member 26 typically is provided on the tip face of the first tip member 22 so as to protrude further towards the tip side, thus assuring the space 55. The space 55 typically serves to store the liquid fraction of the fluid sucked into the barrel 40, and make it easier to intake gas into the torso member 21 of the first plunger 20. Without the space 55, it is more likely that all of the fluid sucked into the barrel 40 will be sucked into the torso member 21 of the first plunger 20 and contact the liquid. Consequently, the carbon dioxide might not be detected. The space-forming member 26 does not close the cylinder member 42, inside the barrel 40, or the hole 23 of the first tip member 22.

The space-forming member 26 may take any shape capable of exhibiting the above functions. For example, the space-forming member 26 may comprise a cylinder having walls completely surrounding the hole 23 of the first tip member 22, or may comprise a shape having a plurality of legs longitudinally in the axial direction. As shown in FIG. 2, the contacting member 26a, which contacts the inner wall 41a on the tip side of the barrel 40, may be disposed on the tip side of the space-forming member 26. The materials comprising the space-forming member 26 and the contacting member 26a are not specifically limited, and these members may comprise, for example, a synthetic resin.

Although the example is shown of a configuration in which the space-forming member 26 is disposed to the space 55, the space need not necessarily be provided by disposing the space-forming member 26 so long as the space 55 is formed between the inner wall 41a on the tip side of the barrel 40 and the tip face of the first tip member 22; that is, as long as the first tip member 22 of the first plunger 20 is prevented from contacting the inner wall 41a on the tip side of the barrel 40. For example, a stopper may be provided on the base side of the torso member 21 so as to assure a space of a predetermined volume between the inner wall 41a on the tip side of the barrel 40 and the tip face of the first tip member 22. In such a case, it is convenient to have the operating member 25 function as a stopper to stop the first plunger 20 moving towards the tip side by causing the operating member 25 to contact the base edge of the barrel 40.

Detecting Member 60

The detecting member 60 typically is arranged inside the torso member 21 of the first plunger 20 at a location closer to the tip side than the second tip member 32 of the second plunger 30, and discolors when it reacts with carbon dioxide. For example, when the fluid (gas) sucked into the torso member 21 of the first plunger 20 is carbon dioxide, the detecting member 60 reacts with the carbon dioxide and discolors. The detecting member 60 may use any conventional technique capable of detecting carbon dioxide. For example, the detecting member 60 may comprise a sheet-like material that discolors when it contacts carbon dioxide. The detecting member 60 should be located inside the torso member 21. The detecting member 60 can detect even a small volume of carbon dioxide, however, if located close to the suction inlet of the torso member 21; specifically, close to the hole 23 of the first tip member 22.

Adaptor 70

The tip of the adaptor 70 typically is connected to the base 10b of the medical tube 10, and the base thereof is connected to the connector 75, thus functioning to connect the medical tube 10 to the syringe 50 through the connector 75. The adaptor 70 typically is connected to the connector 75 in a freely mountable and dismountable manner, allowing the medical tube 10 to be easily mounted and dismounted through the adaptor 70. FIG. 1 shows an example in which the diameter of the adaptor 70 becomes smaller towards the tip. FIG. 1 also shows a configuration in which a cap 71 is disposed on the base of the adaptor 70.

The adaptor 70 may comprise a clear synthetic resin allowing the flow of fluid to be easily recognized. Although FIG. 1 shows an example in which the base 10b of the medical tube 10 is connected to the tip of the adaptor 70, the medical tube 10 may remain in a freely mountable and dismountable manner. The connecting method between the medical tube 10 and the adaptor 70 is not specifically limited. Although the adaptor 70 is not an essential member of device 100, it is provided that the adaptor can improve operability. If the adaptor 70 is not provided, the medical tube 10 may be connected to the tip of the connector 75. The cap 71 typically functions to prevent liquid dripping from the adaptor 70 when the adaptor 70 is removed from the connector 75. The cap 71 is not an essential member. Although the explanation provided herein discusses a configuration in which the adaptor 70 and the medical tube 10 are separate members, the adaptor 70 may be configured so as to be integrated with the medical tube 10.

Connector 75

The tip of the connector 75 typically is connected to the adaptor 70, and the base typically is connected to the cylinder 42 of the barrel 40, thus functioning to connect the medical tube 10 to the syringe 50. As shown in FIG. 1, when the tip side of the connector 75 comprises a catheter-tip shape, the adaptor 70 can be more easily mounted and dismounted. This also prevents erroneous connections. Although FIG. 1 shows an example in which the base side of the connector 75 is screwed onto the periphery of the cylinder 42 of the barrel 40, the shapes of the tip and the base of connector 75 are not limited to the shapes shown in FIG. 1, and may take a lure-like shape. In such a case, the base of the adaptor 70 and the cylinder 42 typically also may take either a male lure shape or a female lure shape.

The connector 75 preferably comprises a clear synthetic resin allowing the flow of the fluids to be easily seen. Although the connector 75 is not an essential part of device 100, providing the connector can improve operability. If the connector 75 is not provided, the adaptor 70 is connected to the cylinder 42. If neither the adaptor 70 nor the connector 75 is provided, the base 10b of the medical tube 10 may be directly connected to the cylinder 42.

Techniques Utilizing Device 100

An exemplary explanation regarding the techniques utilizing device 100 is provided below.

First, an operator prepares the device 100. Subsequently, the operator measures the approximate length of the medical tube 10 to be inserted (specifically, the length reaching the stomach). If a guide wire is utilized, whether the tip of the guide wire has been inserted correctly to reach the tip member 10a of the medical tube 10 must be checked. When a guide wire is utilized, the medical tube 10 is preferably inserted with the medical tube 10 and the adaptor 70 removed from the connector 75. The base of the guide wire is preferably fitted inside the adaptor 70.

Subsequently, the operator applies an anesthetic lubricant (for example, lidocaine gel, etc.) on medical tube 10 from tip member 10a thereof to a location 15 cm to 20 cm down from, the tip to lubricate medical tube 10, and then starts inserting the tube into oral cavity or the nasal cavity. The operator causes tip member 10a of medical tube 10 to reach the target digestive tract such, as the stomach or duodenum, etc. After tip member 10a of medical tube 10 has reached the target digestive tract of the patient, the guide wire is removed from medical tube 10. Subsequently, the operator removes cap 71 of adaptor 70, and connects syringe 50 to the base of adaptor 70 through connector 75.

In order to check whether or not tip member 10a of medical tube 10 has reached the target digestive tract, the operator injects air by pushing first plunger 20, and then checks the presence of air bubble sounds by means of a stethoscope (the first checking operation). If the air bubble sounds are confirmed, the operator can determine that tip member 10a of medical tube 10 might have reached the target digestive tract. As stated above, device 100 is capable of injecting the air that is necessary to conduct the first checking operation without utilizing another device. The device 100 is capable of conducting the second checking operation while the injection of air is going on; in other words, even when the device remains connected to medical tube 10.

Subsequently, the operator pulls first plunger 20 to reduce the pressure within barrel 40 and eventually to suck in the body fluid from tip member 10a of medical tube 10. Subsequently, the operator checks whether or not first plunger 20 has been pulled; in other words, whether or not the body fluid has been successfully sucked in (the second checking operation). If the body fluid is successfully sucked in, the operator is able to determine that the likelihood of tip member 10a of medical tube 10 having reached the target digestive tract is furthermore increased. At this time, the operator also visually checks whether or not the body fluid has been successfully sucked in. It is unknown at this stage whether or not the sucked in body fluid is a digestive fluid. The pH of the fluid that has been sucked into barrel 40 may be checked by means of litmus paper, BTB solution, pH meter, etc. If the resulting pH indicates a value showing the properties of the digestive fluid that is secreted from the target digestive tract, for example, the operator is able to determine that the likelihood that the medical tube has reached the target digestive tract is further increased.

However, even when air bubble sounds are confirmed in the first checking operation, and even when the fluid suction is confirmed in the second checking operation, it is still not certain that tip member 10a of medical tube 10 has reached the target digestive tract. Thus, device 100 is further capable of conducting the third checking operation, in addition to the air injection necessary to conduct the first checking operation as well as the second checking operation. That, is, the more checking operations that are conducted, the higher the likelihood that erroneous indwelling of the tip member 101 will be noticed. Thus, the device 100 can carry out a plurality of checking operations using a single device.

The operator pulls second plunger 30, reduces the pressure within torso member 21 of first plunger 20, and causes only the gas fraction of the fluid, which has been sucked into barrel 40, to be sucked in torso member 21 of first plunger 20. Subsequently, the operator checks whether or not detecting member 60, which is provided on torso member 21 of first plunger 20, reacts (the third checking operation). If detecting member 60 reacts, the operator is easily able to confirm in a visual manner that the sucked-in gas is carbon dioxide, and thereby is able to determine that tip member 10a of medical tube 10 has reached not the target digestive tract, but rather the lower airway, such as the bronchi or the lungs. On the other hand, if detecting member 60 does not react, the operator is able to determine that the likelihood that tip member 10a of medical tube 10 reached the target digestive tract is furthermore increased.

If any of the checking operations, namely the confirmation of air bubble sounds through the first checking operation, confirmation of the body fluid through the second checking operation, and detection of carbon dioxide through the third checking operation, does not confirm that tip member 10a of medical tube 10 has been indwelt at an appropriate location, the operator is then able to determine that the likelihood is high that tip member 10a of medical tube 10 reached not the target digestive tract, but rather the lower airway such as the bronchi or the lungs; in other words, that tip member 10a has been erroneously indwelt. In such case, medical tube 10 needs to be immediately removed, and re-inserted. By conducting all of the checking operations from, the first to the third, it becomes possible to increase the reliability of the judgment regarding whether or not tip member 10a of medical tube 10 has been indwelt at an appropriate location.

On the other hand, if a high likelihood that tip member 10a of medical tube 10 has been indwelt at an appropriate location is confirmed in all of the checking operations from the first, to the third, the operator is then able to determine that the likelihood is very high that tip member 10a of medical tube 10 has reached the target digestive tract. In such case, medical tube 10 is fixed with a surgical tape and the like, and the series of operations for inserting the medical tube 10 is completed.

Thus, if nutrients are provided through the medical tube 10, the syringe 50 and the connector 75 are both removed from the adaptor 70, and a tube for providing nutrients can be connected to the adaptor 70. When draining the contents of the digestive tract through the medical tube 10, the syringe 50 and the connector 75 are both removed from the adaptor 70, and a draining tube connected to a suction device such as a negative pressure generator or the like can be connected to the adaptor 70. If not carrying out feeding or draining, the cap 71 is preferably mounted on the adaptor 70.

As stated above, according to the device 100 of Embodiment 1, the following excellent effects are obtained. According to the device 100, a plurality of checking operations can be carried out using a single device by simple techniques. Therefore, according to the device 100, because the indwelling sites of the tip member 10a of the medical tube 10 are checked through a plurality of checking operations, the reliability of judging whether or not the tip of the medical tube has been indwelled appropriately is greatly improved. According to the device 100, unlike methods using radiography or endoscopy, because the indwelling sites of the tip member 10a of the medical tube 10 are checked through simple techniques, no large-scale equipment is necessary, and no high level of expertise is required from the operator. Therefore, the device 100 is extremely superior in terms of versatility and cost effectiveness.

### Embodiment 2

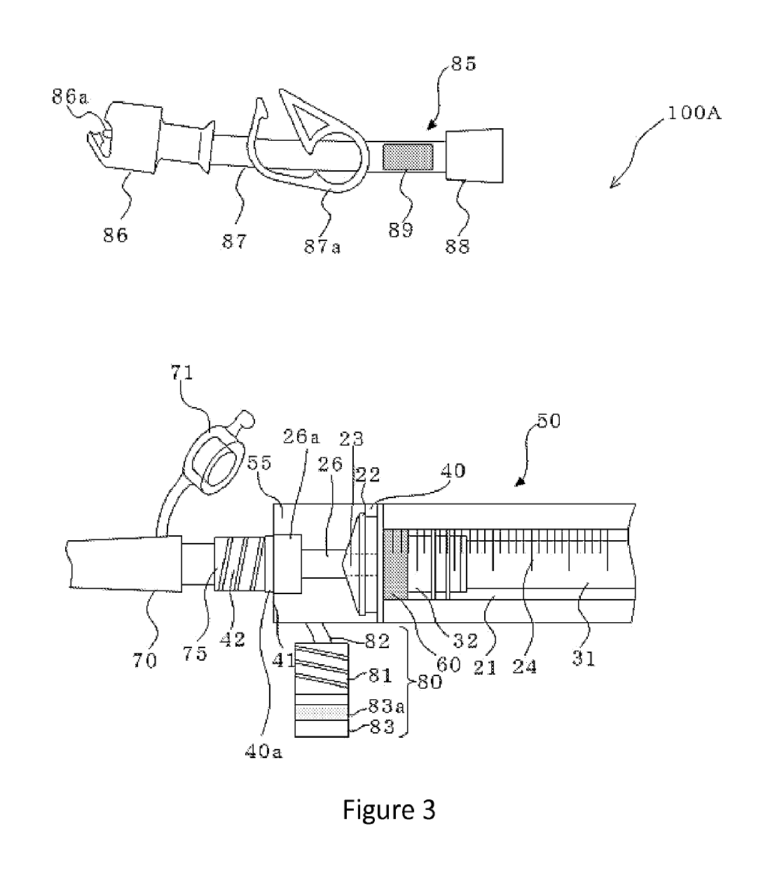

FIG. 3 is a schematic view exemplarily showing the overall configuration of a device for checking indwelling site (hereafter, referred to as the device 100A) of Embodiment 2 of the present invention. The device 100A will be described using FIG. 3 as a reference. Like the device 100 of Embodiment 1, the device 100A is a medical device that is used to insert a medical tube 10 orally or intranasally to indwell the tip 10a thereof in the digestive tract, such as the stomach or the duodenum, and thereby administer nutrition or cause the contents of the digestive tract to be discharged from the digestive tract. Embodiment 2 will be primarily described in terms of the differences from embodiment 1, and an explanation regarding the portions that are the same as Embodiment lis omitted by assigning the same reference numerals to such portions.

The device 100A can carry out three of the following checking operations in a single device: when inserting the medical tube 10 or administering nutrients, air for checking air bubble sounds can be injected, body fluids can be detected and checked, carbon dioxide can be detected and checked, and the pH of the body fluid can be checked. Specifically, the device 100A can carry out checking the pH of the sucked-in body fluid (a fourth checking operation) in addition to the second and third checking operations of Embodiment 1. That is, the more checking operations that are conducted, the more likely it is to detect the erroneous insertion and indwelling of the tip 10a. The device 100A can carry out a plurality of checking operations using one device, and thus enhances the reliability of determining the indwelling site of the tip 10a.

Configuration of Device 100A

The basic configuration of the device 100A is similar to the device 100 of Embodiment 1 shown in FIG. 3. The device 100A differs from the device 100 in having a body fluid retrieving member 80 mounted on the barrel 40, and a connecting tube 85 connected to the body fluid retrieving member 80. Otherwise, the configuration of the device 100A is the same as the configuration of the device 100 in Embodiment 1.

Body Fluid Retrieving Member 80

The body fluid retrieving member 80 can have a nearly cylindrical casing 81, a cylindrical connector 82 arranged projecting from the tip side of the casing 81, and a linking member 83 arranged on the base side of the casing 81.

The casing 81 typically comprises a synthetic resin or the like, is nearly cylindrical, and has openings on the tip side axially (on the side of the barrel 40) and on the rear edge side (the side of the connecting tube 85). The cylindrical connector 82 is arranged projecting from the tip of the casing 81, and is nearly coaxial with the casing 81. The inner cavity of the casing 81 communicates with the inner cavity of the barrel 40 through the cylindrical connector 82. The body fluid retrieving member 80 may be fixed onto the barrel 40 through the cylindrical connector 82, or remain freely mountable and dismountable.

The tip of the cylindrical connector 82 typically is connected to the barrel 40, and the base typically is connected to the casing 81 to communicate between the inner cavity of the barrel 40 and the inner cavity of the casing 81. The diameter and the length of the cylindrical connector 82 are not specifically limited, as long as the cylindrical connector 82 communicates between the inner cavity of the barrel 40 and the inner cavity of the casing 81. The tip of the cylindrical connector 82 may be mounted on a part of the wall of barrel 40, or alternatively cylindrical connector 82 may be formed so as to be integrated with barrel 40. The casing 81 may be mounted in a freely mountable or dismountable manner onto the base of cylindrical connector 82, which is connected to barrel 40; alternatively, cylindrical connector 82 and casing 81 may be formed so as to be mutually integrated.

Linking member 83 typically is provided on the base of casing 81, and it provides the linkage to the tip of connecting tube 85 shown additionally in FIG. 3. To prevent the inner cavity of barrel 40 from, being accidentally linked, to the outer air through the inner cavity of casing 81 when connecting tube 85 is not linked, linking member 83 preferably has a closure member such as a septum (a flexible member such as rubber), cap, and the like. FIG. 3 shows an example in which septum 83a is provided on linking member 83. In such a case as the above in which septum 83a is provided, it is necessary to form a space that is capable of accommodating the septum, on either linking member 83 or casing 81. If septum 83a is provided, a slit that allows casing 81 and connecting tube 85 to mutually link must be formed on septum 83a.

Connecting Tube 85

Connecting tube 85 typically comprises tip linking member 86, which provides a linkage to linking member 83; tube main body 87, which is connected to tip linking member 86; body fluid stopper 88, which is provided on the base of tube main body 87; and pH detecting member 89, which is provided in the inner cavity of tube main body 87.

Tip linking member 86 typically is provided on the tip side of tube main, body 87, and typically is constituted, so as to be linkable to linking member 83 of body fluid retrieving member 80. The constitution of tip linking member 86 is not specifically limited, as long as it is constituted to be linkable to linking member 83 of body fluid retrieving member 80. For example, tip linking member 86 may be constituted as a male connector, and linking member 83 of body fluid retrieving member 80 may be constituted as a female connector so that these members are fit or screwed, together to be connected. The male/female assignments may be reversed. Specifically, tip linking member 86 may be constituted by utilizing general connectors.

However, linking member 83 of body fluid retrieving member 80 may be constituted to be linkable to tip-side linking member 86. As shown in FIG. 3, if septum 83a is provided on linking member 83 of body fluid retrieving member 80, linking tube 86a, which can be inserted into the slit formed on septum 83a, needs to be provided. The connection constitution of body fluid retrieving member 80 and connecting tube 85 is not limited to the constitution shown in FIG. 3, and connection constitutions that are widely utilized may be used.

Tube main body 87 typically allows the body fluids retrieved by body fluid retrieving member 80 to pass through. Tube main body 87 may be constituted with a synthetic resin such as polyvinyl chloride, which is a flexible tube material and does not contain polyurethane or plasticizers. The length and diameter of tube main body 87 are not specifically limited, and commonly-utilized tubes may be utilized to constitute tube main body 87, FIG. 3 shows an example in which clamp 87a is provided on tube main body 87. Clamp 87a closes and opens the inner cavity of tube main body 87 in a freely closeable/openable manner. Clamp 87a is not an essential member, and the operator may close and open the inner cavity of tube main body 87 by utilizing their fingers.

Body fluid stopper 88 typically is provided on the base of tube main body 87, and can prevent the body fluid coming out of tube main body 87 from flowing out of connecting tube 85. Body fluid stopper 88 may be constituted with a hydrophobic filter and the like which allows only gases to pass through. Other members of different connection constitutions may be connected to body fluid stopper 88. In such case, a balloon, syringe, negative pressure generator, and the like may be connected to body fluid stopper 88 as examples so that the body fluid that has been sucked into barrel 40 is sucked to the side of body fluid retrieving member 80.

pH detecting member 89 typically reacts with the body fluid guided into tube main body 87, thereby to detect the pH of the body fluid. pH detecting member 89 may be constituted with any material, as long as it can be accommodated within tube main body 87 and is capable of detecting pH. For example, pH detecting member 89 may be constituted with litmus paper.

Techniques Utilizing Device 100A

An exemplary explanation regarding the techniques utilizing device 100A is provided below. The techniques for the first to the third checking operations are similar to those discussed for device 100 in embodiment 1.

When it has been confirmed through the second checking operation that the body fluid has been sucked in, the operator retrieves the body fluid, which has been sucked into barrel 40, into body fluid retrieving member 80, for example, by means of specific gravity or sucking force. Subsequently, the operator connects connecting tube 85 to body fluid retrieving member 80. When connecting tube 85 becomes connected to body fluid retrieving member 80, the inner cavity of tube main body 87 is opened to transfer the body fluid, which has been retrieved into body fluid retrieving member 80, to the side of connecting tube 85. Subsequently, the operator supplies the body fluid to pH detecting member 89, which is provided on tube main body 87, and checks the pH of the body fluid through the operations of pH detecting member 89 (the fourth checking operation).

If the pH that is detected by pH detecting member 89 is a value that indicates the properties of the digestive fluid secreted from the target digestive tract, for example, the operator is then able to determine that the likelihood of tip member 10a of medical tube 10 having reached the target digestive tract is furthermore increased. The fourth checking operation may be conducted in parallel with the third checking operation discussed in embodiment 1, subsequent to the third checking operation, or prior to the third checking operation. Specifically, the more checking operations that are conducted, the more likely it is to detect the erroneous insertion and indwelling of tip 10a. Device 100A enables a multiple number of checking operations in a single device, and thus it enhances the reliability of determining the indwelling site of the tip 10a.

If there is any of the checking operations, namely the confirmation of air bubble sounds through the first checking operation, confirmation of the body fluid through the second checking operation, detection of carbon dioxide through the third checking operation, or confirmation of the pH of the body fluid through the fourth checking operation, that does not confirm that tip member 10a of medical tube 10 has been indwelt at an appropriate location, the operator is then able to determine that the likelihood that tip member 10a of medical tube 10 has reached the lower airway such as the bronchi or lungs, instead of the target digestive tract-namely, that it has been erroneously indwelt, is high. By conducting all of the checking operations from the first to the fourth, it becomes possible to increase the reliability of the judgment regarding whether or not the tip member 10a of the medical tube 10 has been indwelt at an appropriate location. On the other hand, if the high likelihood of the tip member 10a of the medical tube 10 having been indwelt at an appropriate location is confirmed in all of the first to the fourth checking operations, the operator can then determine that the likelihood that the tip member 10a of the medical tube 10 has reached the target digestive tract is very high. In such a case, the medical tube 10 is fixed with a surgical tape or the like, and the series of operations for inserting the medical tube 10 is completed.

As stated above, according to the device 100A of Embodiment 2, the following excellent effects can be obtained. According to the device 100A, a plurality of checking operations can be carried out using a single device by simple techniques. Therefore, according to the device 100A, because the indwelling site of the tip member 10a of the medical tube 10 is checked through one more additional checking operation in addition to the two checking operations that can be carried out by the device 100 of Embodiment 1, the reliability of judging whether or not the tip of the medical tube has been indwelled appropriately is furthermore improved. According to the device 100A, unlike methods that utilize radiography or endoscopy, because the indwelling site of the tip member 10a of the medical tube 10 is checked through simple techniques, no large-scale equipment is necessary, and no high level of expertise is required from the operator. Therefore, the device 100A is extremely superior in terms of versatility as well as cost effectiveness.

In the embodiments, an example is provided in which medical tube 10 is inserted by utilizing a guide wire. However, the embodiments are not limited to the above, and the medical tube 10 may be inserted without utilizing a guide wire.

TABLE 1
Listing of the Reference Numerals

```
  10: Medical tube
  10a: Tip
  10b: Base
  20: First plunger
  21: Torso member
  22: First tip member
  23: Hole
  24: Scale
  25: Operating member
  26: Space-forming member
  26a: Contacting member
  30: Second plunger
  31: Stick-like member
  32: Second tip member
  35: Operating member
  40: Barrel
  41: Tip member
  41a: Inner wall
  42: Cylinder
  43: Operating member
  44: Scale
  50: Syringe
  55: Space
  60: Carbon dioxide detecting member
  70: Adaptor
  71: Cap
  75: Connector
  80: Body fluid retrieving member
  81: Casing
  82: Cylindrical connector
  83: Linking member
  83a: Septum
  85: Connecting tube
  86: Tip linking member
  86a: Linking tube
  87: Tube main body
  87a: Clamp
  88: Body fluid stopper
  89: pH detecting member
100: Device for checking indwelling site
100A: Device for checking indwelling site
```

1. A device for checking an indwelling site of a tip of a medical tube, comprising:
a barrel for connecting to a medical tube,
a first plunger having a hollow torso member and a first tip member disposed on the tip of the torso member and having a hole formed communicating between an inner cavity of the torso member and an inner cavity of the barrel, the first plunger capable of pushing into or pulling out of the barrel,
a second plunger having a second tip member, and disposed capable of pushing into or pulling out of the torso member, and
a carbon dioxide detecting member in the torso member and closer to the tip than to the second tip member,
wherein the first plunger is restricted from moving towards the tip at a location where the first tip member does not contact the inner wall of the barrel on the tip side, and has a space having a predetermined volume formed between the tip face of the first tip member and the inner wall of the barrel on the tip side.

2. The device for checking an indwelling site according to claim 1, wherein the first plunger is restricted from moving towards the tip by a space forming member disposed on the tip of the first tip member or a stopper disposed at the base of the first plunger.

3. The device for checking an indwelling site according to claim 1, wherein a hydrophobic filter is disposed in the hole formed in the first tip member.

4. The device for checking an indwelling site according to claim 1, further comprising:
a connector having a tip formed in a catheter-tip shape and connecting so as to freely mount onto or dismount from the tip of the barrel, and
an adaptor linked to the base of the medical tube and connecting so as to freely mount onto or dismount from the tip of the connector.

5. The device for checking an indwelling site according to claim 1, further comprising:
a body fluid collecting member for collecting fluid sucked into the barrel from the barrel, and
a connecting tube for connecting so as to freely mount onto or dismount from the body fluid collecting member.
